(19) United States
(12) Patent Application Publication
(10) Pub. No.: US 2006/0190678 A1
(43) Pub. Date: Aug. 24, 2006

(54) Static random access memory (SRAM) compatible, high availability memory array and method employing synchronous dynamic random access memory (DRAM) in conjunction with a single DRAM cache and tag

(76) Inventors: Douglas Blaine Butler, Colorado Springs, CO (US); Oscar Frederick Jones JR., Colorado Springs, CO (US); Michael C. Parris, Colorado Springs, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 11/062,974

(22) Filed: Feb. 22, 2005

(51) Int. Cl. G06F 13/28

(52) U.S. Cl. 711/106; 711/118

(57) ABSTRACT

A static random access memory (SRAM) compatible, high availability memory array and method employing synchronous dynamic random access memory (DRAM) in conjunction with a single DRAM cache and tag provides a memory architecture comprising low cost DRAM memory cells that is available for system accesses 100% of the time and is capable of executing refreshes frequently enough to prevent data loss. Any subarray of the memory can be written from cache or refreshed at the same time any other subarray is read or written externally.

### BACKGROUND OF THE INVENTION

The present invention relates, in general, to the field of integrated circuit memory devices and those devices incorporating embedded memory. More particularly, the present invention relates to a static random access memory (SRAM) compatible, high availability memory array and method employing synchronous dynamic random access memory (DRAM) in conjunction with a single DRAM cache and tag, hereinafter sometimes referred to as SCRAM (SRAM Compatible Random Access Memory).

SRAM is a type of memory technology which can maintain data without needing to be refreshed for as long as power is supplied to the circuit (i.e. “static”). This is, in contrast to DRAM which must be refreshed many times per second in order to maintain its data (i.e. “dynamic”). Among the main advantages of SRAM over DRAM is the fact that the former doesn't require refresh circuitry in order for it to maintain data, unlike the latter. For this and other reasons, the data access speed of SRAM is generally faster than that of DRAM. Nevertheless, SRAM is, on a byte-for-byte storage basis, more expensive to produce than DRAM due primarily to the fact that SRAMs take up much more on-chip area than DRAMs since SRAM is generally made up of four, six or even more transistors per memory cell. A DRAM cell, in contrast, generally comprises one transistor and one capacitor.

As mentioned previously, DRAM is constructed such that it only maintains data if it is fairly continuously accessed by refresh logic. Many times per second, this circuitry must effectively read the contents of each memory cell and restore each memory cell regardless of whether the memory cell is otherwise currently being accessed in a data read or write operation. The action of reading and restoring the contents of each cell serves to refresh the memory contents at that location.

Among the advantages of DRAMs are that their structure is very simple and each cell typically comprises but a single small capacitor and an associated pass transistor. The capacitor maintains an electrical charge such that, if a charge is present, then a logic level “1” is indicated. Conversely, if no charge is present, then a logic level “0” has been stored. The transistor, when enabled, serves to read the charge of the capacitor or enable writing of a bit of data to it. However, since these capacitors are made very small to provide maximum memory density and they can, under the best of circumstances, only hold a charge for a short period of time, they must be continually refreshed.

In essence, the refresh circuitry then serves to effectively read the contents of every cell in a DRAM array and refresh each one with a fresh “charge” before the charge leaks off and the data state is lost. In general, this “refreshing” is done by reading and restoring every “row” in the memory array whereby the process of reading and restoring the contents of each memory cell capacitor re-establishes the charge, and hence, the data state.

Consequently, it would be highly advantageous to provide a memory architecture which exhibited the memory density advantages of DRAM while nonetheless being able to provide memory access times approaching that of SRAM through the coordination of refresh operations (hidden refresh) so as not to impede normal memory read/write data access. In this regard, a number of ways of hiding DRAM refresh operation have heretofore been proposed for both synchronous DRAMs (SDRAMs; those memories in which operation of the memory is controlled by “valid” or “invalid” signals relative to the edges of a clock) and asynchronous DRAMs in which no clock synchronization is utilized.

Asynchronous Memory Refresh Hiding Techniques:

An article entitled “1-Mbit Virtually Static RAM”, Nogami et. al., IEEE Journal of Solid-State Circuits, Vol. SC-21, No. 5, October 1986 pp. 662-667 describes a particular method for hiding refresh operations in an asynchronous DRAM, but as shown in Table IV at page 666 m it is not completely compatible with (asynchronous) SRAMs. In addition a significant access time and cycle time penalty is incurred in its implementation.

A different article entitled: “4 Mb Pseudo/Virtually SRAM”, Yoshioki, et. al., 1987 IEEE International Solid-State Circuits Conference, Digest of Technical Papers pp. 20-21 and 1987 ISSCC pp. 320-322 describes another method for hiding refresh that effectively increases the address access time from 60 nS to 95 nS, resulting in an unacceptably large performance penalty.

U.S. Pat. No. 6,625,077 issuing Sep. 23, 2003 to Chen for: “Asynchronous Hidden Refresh of Semiconductor Memory” describes a method for hiding refresh operations in an asynchronous DRAM by “stretching” all read or write cycles. The exact performance penalty incurred through implementation of the technique is not disclosed but would be significant.

Similarly, U.S. Pat. No. 6,445,636 issuing Sep. 3, 2003 to Keeth et al. for: “Method and System for Hiding Refreshes in a Dynamic Random Access Memory” describes a method for hiding DRAM refresh by doubling the number of memory cells, thus effectively doubling the silicon area required. The method indicated incurs an unacceptably large cost penalty.

Synchronous Memory Refresh Hiding Techniques:

U.S. Pat. No. 5,999,474 issuing Dec. 7, 1999 to Leung et al. for “Method and Apparatus for Complete Hiding of the Refresh of a Semiconductor Memory” (hereinafter sometimes referred to as the “'474 patent”) describes a method for hiding refresh in what appears to be an SDRAM (this is inferred by the CLK signal in FIG. 4) utilizing among other things a static RAM (SRAM) cache of the same size as one of the DRAM subarrays. Since, as previously noted, SRAM cells are much larger than DRAM cells, the physical size of the SRAM cache will be a significant penalty in implementing the method shown. U.S. Pat. No. 6,449,685 also to Leung issuing Sep. 10, 2002 for “Read/Write Buffers for Complete Hiding of the Refresh of a Semiconductor Memory and Method of Operating Same” (hereinafter sometimes referred to as the “'685 patent”) addresses the issue of the size of an SRAM cache by replacing it with two DRAM caches of the same size. The two DRAM caches are somewhat misleadingly referred to as a write buffer and read buffer in FIG. 5, but each buffer has the same capacity as the SRAM cache shown in FIG. 1, so they are, in reality, caches.

In both the '474 and '685 patents, a cache may contain data from multiple subarrays at any one time. This imposes a size requirement on the tag SRAM memory that is equal to the number of words (a word being equal to the number of bits per address) in a subarray multiplied by (2+the number of bits required to uniquely address each subarray). A further fundamental limitation on the methods described is that the SRAM cache implements a write-back policy, such that all write data is initially written to the SRAM cache before being written to the memory banks, and all read data provided to the external data bus is stored in the SRAM cache. Since the data written to cache will be eventually written to the subarrays, the writes to cache consume power that would not be necessary for a DRAM not hiding refresh. Since the cache is expected to consume more power than a DRAM subarray per access, this write to cache before writing to a subarray is expected to more than double array power for writes. For random reads, 63 of 64 reads will be misses. Reading the subarray and writing to the cache is also expected to more than double the power 63 of 64 times. U.S. Patent Application Ser. No. 2003/0033492 to Akiyama et al. for: “Semiconductor Device with Multi-Bank DRAM and Cache Memory is very similar to that described in the '685 patent.

In general, the primary deficiencies of the known techniques for hiding refresh operations in asynchronous and synchronous DRAMs are that either an SRAM cache or two DRAM caches are required in addition to a tag capacity larger than might be desired.

### SUMMARY OF THE INVENTION

Disclosed herein is a static random access memory (SRAM) compatible, high availability memory array and method employing synchronous dynamic random access memory (DRAM), hereinafter sometimes referred to as SCRAM (SRAM Compatible Random Access Memory), which enables 100% memory system availability in a memory array comprising DRAM memory cells with only a single DRAM cache and a smaller tag than utilized in conventional techniques.

Specifically, the memory array and method of the present invention employs a cache which “mirrors” data from but a single subarray at any given time. In contrast, the techniques described in the '474 and '685 patents allows data from any or all subarrays to be in the cache concurrently and does not disclose the concept of the cache “mirroring” a subarray. As described in the '474 and '685 patents, the tag that tracks which data in the cache is valid must have one bit to indicate if the data is valid, a second bit to indicate invalid data in the array and also enough bits to contain the subarray address. For example, if 16 subarrays are present an extra 4 bits are required for the subarray address, thus increasing the capacity of the tag by 6×. In accordance with the present invention, a 4 bit register contains the information of which subarray is being “mirrored” and there is no need for a tag bit to indicate invalid array data.

Also in accordance with the present invention, the cache may be advantageously composed of a number of DRAM memory cells equal to the number of DRAM memory cells in a subarray. In the '474 patent, the cache comprises a number of SRAM memory cells equal to the number of DRAM memory cells in a subarray, while in the '685 patent, two caches are utilized, each with a number of DRAM memory cells equal to the number of DRAM memory cells in a subarray. Still further, the present invention may be implemented utilizing a single refresh counter as opposed to the implementation described in the '474 and '685 patents which place a refresh counter in each subarray.

As disclosed herein in a particular implementation of the present invention, the DRAM array (comprising all of the plurality of subarrays) has two address busses, with one address bus dedicated to the external address while the other can be used for either the refresh address or the write-back address. Moreover, the DRAM array of the present invention is issued bus specific enable (activate) commands. In other words, a wordline in an array will be driven “high” if, and only if, that array address is on the bus and an enable is issued for that bus. The technique of the '474 and '685 patents appears to use one enable command for each subarray.

In accordance with the present invention, the availability of a memory to system accesses, built from DRAM memory cells, is increased to 100%. In order to achieve 100% availability and prevent data loss, refresh of the DRAM memory cells must be possible for all combinations of system accesses. Refresh is enabled under most access sequences by the use of multiple independently operable subarrays whereas refresh is assured for all access sequences by utilizing a cache to temporarily mirror the one of the multiple independently operable subarrays for which refresh is requested. As contemplated herein, the cache is “mirroring” a subarray when it is used to store some or all of the data from that subarray. In the embodiment of the present invention disclosed herein, the cache is capable of storing the entire contents of a subarray.

A read request for data contained in cache allows the subarray for which refresh is requested to be refreshed since the data can be read from cache and the subarray address needing refresh can be refreshed. A write to the subarray for which refresh is requested can be stored in cache thus allowing a refresh to the subarray. A tag is used to track the cache valid data and control logic is used to manage reads to cache, writes to cache and write-backs from cache to the mirrored subarray. Data in the cache is written back to the subarray before the cache can mirror a different subarray.

As utilized herein, the following definitions pertain:

REFRESH POINTER—Refresh is done to one of the subarrays or cache based on the address contained in the refresh pointer. If there are 16 subarrays the subarray addresses could be combinations of a<3:0>. The cache address could be the next refresh address if a<4> is set. In this example, the refresh pointer could count from 00000 through 10000 normally but increment from 10000 to 00000.

MIRRORED SUBARRAY POINTER—Contains the address of the subarray being mirrored by the cache. If there are 16 subarrays the subarray addresses could be sa<3:0> and the mirrored subarray pointer would contain one combination of sa<3:0>.

ROW REFRESH ADDRESS—The address of the row within the subarray or cache to be refreshed generated by the refresh counter. If there are 64 rows (wordlines) in each subarray and in the cache, the row addresses could be ra<0:5>.

REFRESH ADDRESS—The refresh address contains the refresh pointer and the row refresh address.

REFRESH REQUEST—A signal set by the control logic block indicating that a refresh is requested. The exact row to be refreshed is specified by the refresh address. In the representative embodiment disclosed, the REFRESH REQUEST is reset after all rows within one of the subarrays or the cache have been refreshed.

MIRRORING—Data will be transferred to the cache if the cache is “mirroring” the accessed subarray and a refresh is being requested to that subarray. The cache is mirroring a subarray when it is available to cache some or all of the data read from or written to that subarray. The subarray the cache is mirroring will change only if a CACHE CLEAR has been completed. Since the tag contains no subarray address information, the cache is allowed to have valid data from only one subarray at a time.

WRITE-BACK CYCLE—A write-back cycle is initiated when a REFRESH REQUEST is active, an access (read or write) is to the subarray pointed to by the refresh pointer and the mirrored subarray pointer address is not the refresh pointer address. The tag contains one bit for each data word of the cache (data word being defined, for example, as the number of bits addressed by a single cache address). A tag bit set indicates valid data in the cache at the data word location corresponding to that tag bit.

The data transfer is effectuated by checking the tag bit and, if set, resetting the tag bit and transferring the data corresponding to that tag bit to the appropriate subarray. This is repeated for each tag bit, one tag bit per write-back cycle. The write-back address counter supplies the tag address to be checked. When the write-back address counter has incremented from zero to maximum, each tag bit has been checked, all valid data transferred from cache to the appropriate subarray and a CACHE CLEAR is, therefore, complete. The mirrored subarray pointer can then be set to a new subarray.

The subarray address indicated by the mirrored subarray pointer will be reset to the subarray to be refreshed as indicated by the refresh pointer. If the refresh pointer increments to the mirrored subarray pointer address during a CACHE CLEAR, the write-back address counter is reset and the CACHE CLEAR is discontinued. The write-back address counter reset is done so that data loaded into the cache at lower write-back address counter addresses than the write-back address counter address current at the time the CACHE CLEAR is discontinued, will be handled properly when the next CACHE CLEAR is begun.

In particular embodiments of the present invention disclosed herein, a synchronous DRAM device, or other integrated circuit device employing embedded SDRAM is provided that incorporates a control logic block, a DRAM cache, a tag, a write-back address counter and specific data and address bussing. In operation and architecture, there is provided, therefore a memory array which is constructed utilizing low-cost, DRAM memory cells that is available for system accesses 100% of the time and is capable of executing refreshes to the DRAM memory cells frequently enough to prevent data loss. The SCRAM of the present invention is always available to respond to a read or write request and no sequence of accesses, however unlikely, can prevent refresh for a long enough period to cause data loss.

The representative SCRAM disclosed herein comprises multiple memory subarrays. Any subarray can be written from cache or refreshed at the same time any other subarray is being read or written externally. For a SCRAM containing n subarrays, if subarray x is being read or written externally, any of the n subarrays other than x can be refreshed or written from cache. If external accesses are to one subarray continuously, refreshes to that subarray are potentially interfered with. How the SCRAM functions to ameliorate this possible interference is outlined in CASES 1 to 6 below.

CASE 1a

(Continuous Reads to Subarray<x>, Cache Mirroring Subarray<x>)

Continuous reads to subarray<x> will interfere with the refreshing of subarray<x>. Refresh of subarray<x> can be enabled if the data requested from subarray<x> is also available in cache. Data from subarray<x> can be transferred to cache on the cycle it is read externally. A tag is provided to record what data is available in the cache. When data is transferred to cache, the tag bit corresponding to that data is set. To guarantee that data requested from subarray<x> will eventually also be available in cache, the cache must be equal in size to subarray<x>. When, and only when, a cache hit occurs, data is read from cache and subarray<x> is refreshed.

CASE 1b

(Continuous Reads to Subarray<x>, Cache NOT Mirroring Subarray<x>)

Continuous reads to subarray<x> will interfere with the refreshing of subarray<x>. Data from subarray<x> cannot be transferred to cache until a write-back cycle is performed. Since only subarray<x> is being accessed, and the cache is not mirroring subarray<x>, a write-back cycle as described above can be performed in each clock cycle during the continuous reads. Once a CACHE CLEAR is completed as described above and the mirrored subarray pointer set to subarray<x>, CASE 1b then becomes CASE 1a.

CASE 2a

(Continuous Writes to Subarray<x>, Cache Mirroring Subarray<x>)

Writes to subarray<x> will simply be written instead to cache and the tag bit set. Refresh is therefore allowed in subarray<x>.

CASE 2b

(Continuous Writes to Subarray<x>, Cache NOT Mirroring Subarray<x>)

Writes to subarray<x> cannot be written instead to cache until a CACHE CLEAR is completed. Since only subarray<x> is being accessed, and the cache is not mirroring subarray<x>, a write-back cycle as described above can be performed in each clock cycle. Once a CACHE CLEAR is completed as described above and the mirrored subarray pointer set to subarray<x> CASE 2b then becomes CASE 2a.

CASE 3

(Continuous Reads or Writes to Subarray<x>)

A mixture of reads and writes to subarray<x> will be handled as a simple combination of CASE 1 and CASE 2 above.

CASE 4

(REFRESH REQUEST to Cache During Cache Reads)

For continuous reads with cache hits, refresh to cache is interfered with. In this case, data is read from cache and also transferred to the appropriate subarray and the tag bit is cleared. Refresh can be delayed one cycle for each tag bit. After that, a tag “miss” is guaranteed and refresh will occur.

CASE 5

(REFRESH REQUEST to Cache During Cache Writes)

For writes, data is written to the appropriate subarray and the tag bit is cleared. Refresh is allowed on that cycle.

CASE 6

(SCRAM not Accessed)

Refresh will be allowed if a REFRESH REQUEST is active.

From CASES 1 & 2 above it can be seen that for the worst case of data in the cache, refresh can be delayed by a number of cycles equal to 2× the number of tag bits. If the access pattern of subarray<x> is such that there is no delay on one REFRESH REQUEST but 2048 cycles of delay on the next REFRESH REQUEST, the REFRESH REQUEST timing must take this into consideration. For example, if the clock period is 5.0 nS (200 MHz) and the tag contains 2048 bits, this is potentially a delay of 10.24 μS. If the memory is capable of a 64 mS refresh time (typical of commodity DRAMs) the REFRESH REQUEST timing must be set to refresh all arrays in approximately 63.9897 mS.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a functional block diagram of a conventional memory illustrating the data and address bussing thereof and wherein refresh operations are not hidden;

FIG. 2 is a functional block diagram of a memory in accordance with a particular implementation of the present invention illustrating the data and address bussing thereof and wherein refresh of the subarrays and cache may be effectuated in parallel with any combination of external accesses;

FIG. 3 is a further functional block diagram of a memory in accordance with another particular implementation of the present invention wherein control logic and control signals may be used to hide refresh operations in the memory array;

FIG. 4 is a representative state diagram of a hidden refresh operation of a memory in accordance with the present invention with a REFRESH REQUEST “inactive”; and

FIG. 5 is a further representative state diagram of a hidden refresh operation of a memory in accordance with the present invention with a REFRESH REQUEST “active”.

### DESCRIPTION OF A REPRESENTATIVE EMBODIMENT

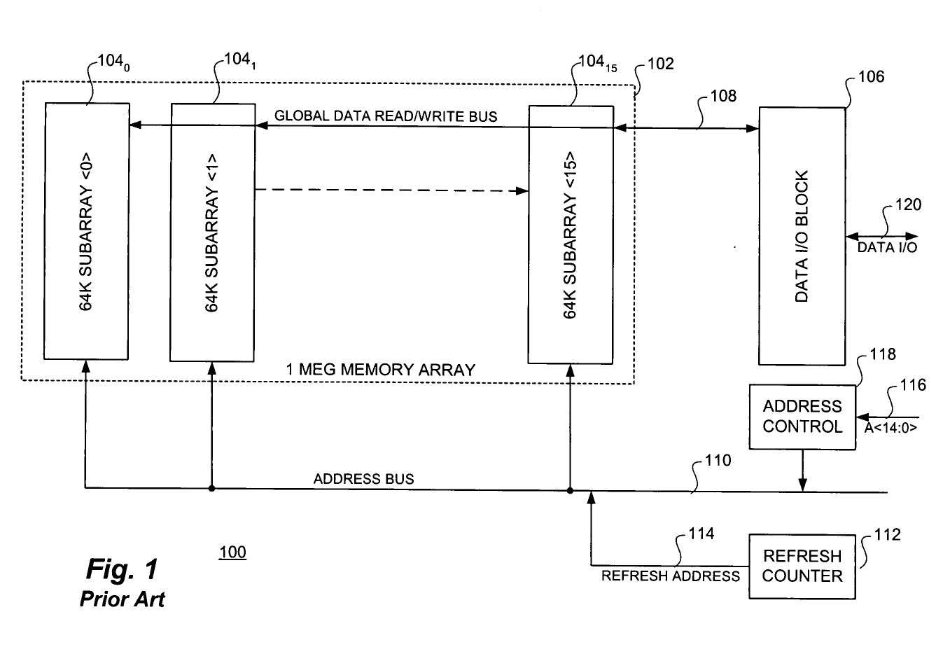

With reference now to FIG. 1, a functional block diagram of a conventional memory 100 is shown illustrating the data and address bussing thereof and wherein refresh operations are not hidden. The conventional DRAM memory 100 comprises, in pertinent part, a 1 Meg memory array 102 comprising 16 separate 64 K subarrays 104₀ through 104₁₅ (subarray <0> through subarray <15>) as illustrated.

A data input/output (I/O) block 106 is coupled to the various subarrays 104₀ through 104₁₅ by means of a global data read/write bus 108. Memory locations within the subarrays 104₀ through 104₁₅ are addressed by means of an address bus 110 or a refresh address determined by a refresh counter 112 which provides a refresh address on bus 114 coupled to the address bus 110. Addresses to be read or written within the memory array 102 are input on address bus 116 (A<14:0>) for input to an address control block 118, which is, in turn, coupled to the address bus 110. Data read from, or to be written to, the memory array 102 is supplied on data bus 120 coupled to the data I/O block 106.

The conventional DRAM memory 100 illustrated depicts the data and address bussing typical of a DRAM device or embedded DRAM memory. A typical DRAM is unable to refresh one subarray 104 while concurrently executing a refresh operation in a different subarray 104 as the single address bus 110 is used to transmit both the external address from the address control block 118 for an external access as well as the refresh address on bus 114 from the refresh counter 112.

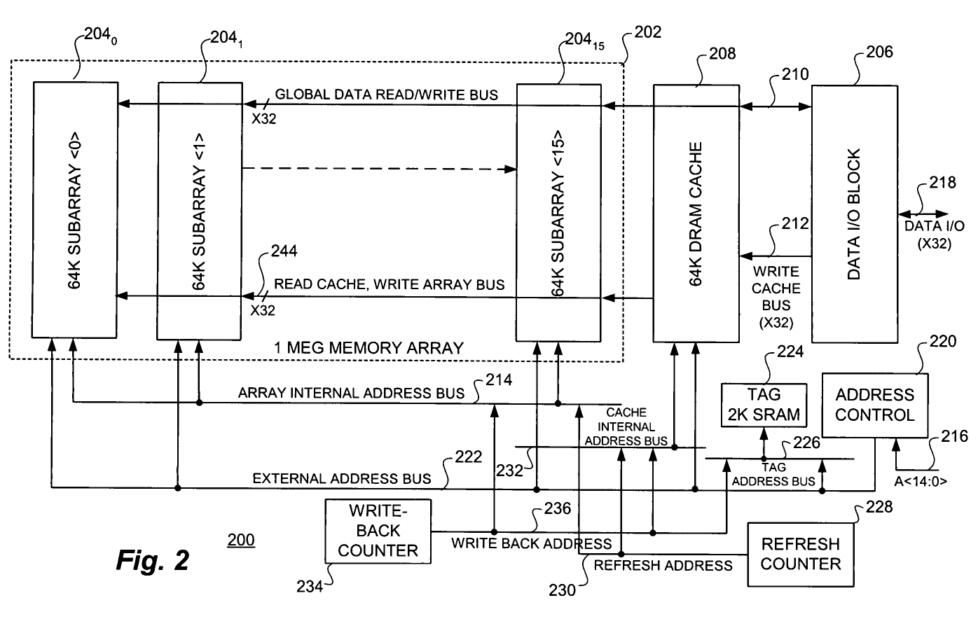

With reference additionally now to FIG. 2, a functional block diagram of a memory 200 in accordance with a first implementation of the present invention is shown illustrating the data and address bussing thereof and wherein refresh of the subarrays and cache may be effectuated in parallel with any combination of external accesses.

The memory 200 comprises, in the particular implementation illustrated, a 1 Meg memory array 202 comprising sixteen 64 K subarrays 204₀ through 204₁₅ (subarray <0> through subarray <15>). A data I/O block 206 is coupled to a 64 K DRAM cache 208 as well as the subarrays 204₀ through 204₁₅ by a global data read/write bus 210. A read cache, write array bus 244 also couples the cache 208 to the 64 K subarrays 204₀ through 204₁₅. Write cache bus 212 couples the data I/O block 206 and the DRAM cache 208. It should be noted that the DRAM cache 208 is the same size as each of the subarrays 204₀ through 204₁₅.

An array internal address bus 214 is coupled to each of the subarrays 204₀ through 204₁₅ and addresses supplied to the memory 200 are input on address bus 216 (A<14:0>) coupled to an address control block 220 while data read from, or input to, the memory 200 is furnished on data I/O bus 218 coupled to the data I/O block 206. An external address bus 222 coupled to the address control block 220 is also coupled to each of the subarrays 204₀ through 204₁₅ as well as to a 64 K DRAM cache 208 and a tag address bus 226 which is coupled to a tag block 224 which, in the implementation shown, may comprise 2 K of SRAM.

A refresh counter 228 is coupled to a refresh address bus 230 which is coupled to the array internal address bus 214 as well as to a cache internal address bus 232. The DRAM cache 208 is coupled to both the cache internal address bus 232 as well as the external address bus 222. A write-back counter 234 is coupled to a write-back address bus 236 which is, in turn, coupled to the array internal address bus 214, the cache internal address bus 232 and the tag address bus 226.

In this figure, the additional data and address bussing utilized for the SCRAM of the present invention is shown. Two address busses service the 1 Meg memory array 202 in the form of an array internal address bus 214 and an external address bus 222. The array internal address bus 214 is multiplexed between the write-back address and the refresh address. The external address bus 222 need not be multiplexed but always asserts an externally supplied address from the address control block 220. The DRAM cache 208 is serviced by the external address bus 222 as well as the cache internal address bus 232. The cache internal address bus 232 is multiplexed between the write-back address and the refresh address. The tag 224 is serviced by only the tag address bus 226 that is multiplexed between the external address and write-back address. The write cache bus 212 allows data in the data I/O block 206 read from the 1 Meg memory array 202 to be written to the DRAM cache 208. The read cache, write array bus 244 can operate on the same cycle as the global data read/write bus 210, even if the DRAM cache 208 is accessed for read operations.

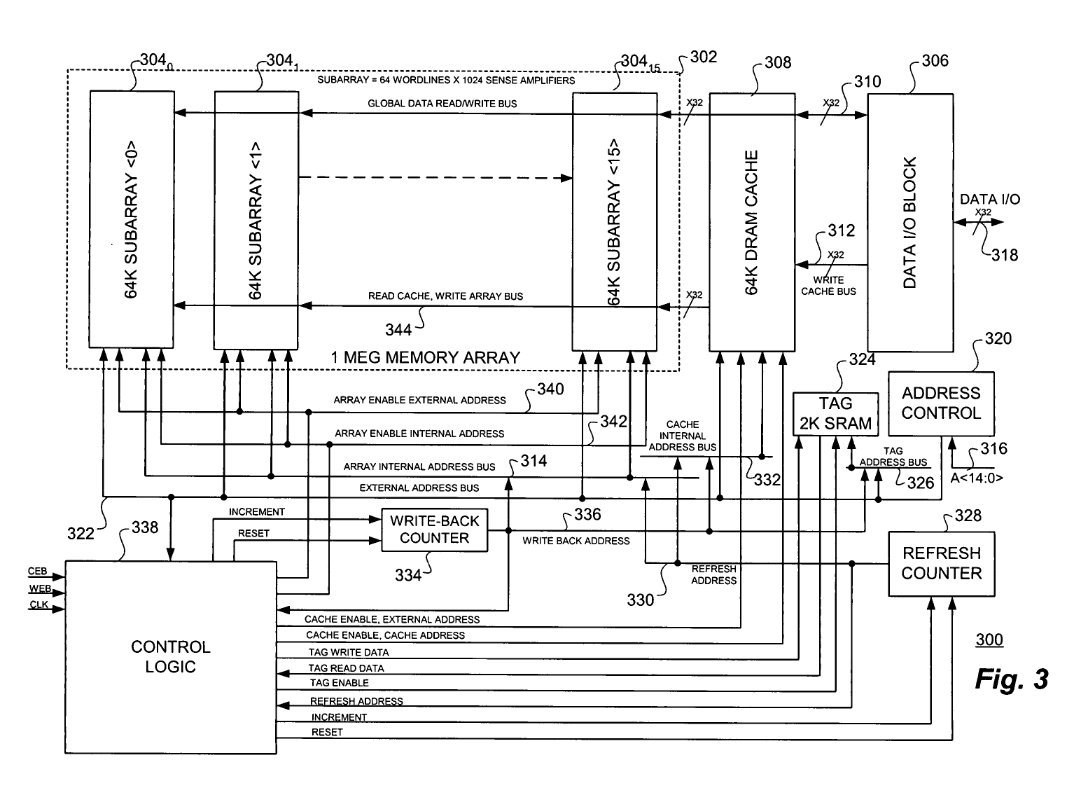

With reference additionally now to FIG. 3, a further functional block diagram of a memory 300 in accordance with the first implementation of the present invention is shown wherein control logic and control signals used to hide refresh operations in the memory array are included.

The memory 300 comprises, in the representative implementation illustrated, a 1 Meg memory array 302 comprising sixteen 64 K subarrays 304₀ through 304₁₅ (subarray <0> through subarray <15>). A data I/O block 306 is coupled to a 64 K DRAM cache 308 as well as the subarrays 304₀ through 304₁₅ by a global data read/write bus 310. A read cache, write enable bus 344 couples the DRAM cache 308 to the subarrays 304₀ through 304₁₅. Write cache bus 312 couples the data I/O block 306 and the DRAM cache 308. As before, the DRAM cache 308 is the same size as each of the subarrays 304₀ through 304₁₅.

An array internal address bus 314 is coupled to each of the subarrays 304₀ through 304₁₅ and addresses supplied to the memory 300 are input on address bus 316 (A<14:0>) coupled to an address control block 320 while data read from, or input to, the memory 300 is furnished on data I/O bus 318 coupled to the data I/O block 306. An external address bus 322 coupled to the address control block 320 is also coupled to each of the subarrays 304₀ through 304₁₅ and 64 K DRAM cache 308 as well as to a tag address bus 326 which is coupled to a tag block 324 which, in the implementation shown, may comprise 2 K of SRAM.

A refresh counter 328 is coupled to a refresh address bus 330 which is coupled to the array internal address bus 314 as well as to a cache internal address bus 332. The DRAM cache 308 is coupled to both the cache internal address bus 332 as well as the external address bus 322. A write-back counter 334 is coupled to a write-back address bus 336 which is, in turn, coupled to the array internal address bus 314, the cache internal address bus 332 and the tag address bus 326.

In the particular, exemplary implementation of the present invention illustrated, the memory 300 further comprises a control logic block 338 which receives, as inputs a chip enable bar (CEB), write enable bar (WEB) and clock (CLK) signal inputs while providing “increment” and “reset” inputs to the write-back counter 334 and the refresh counter 328. The control logic block 338 is further coupled to the external address bus 322 as shown.

The control logic block 338 also drives an array enable external address signal line 340 as well as an array enable internal address signal line 342 which is coupled to each of the subarrays 304₀ through 304₁₅. Output of the write-back counter 334 is also provided to the control logic block 338. A cache enable, external address and cache enable, cache address signals are provided to the DRAM cache 308 from the control logic block 338 which further provides a tag write data and tag enable signals to the tag 324. The tag 324 provides a tag read data signal to the control logic block 338 while the refresh counter 328 provides a refresh address signal as indicated.

Illustrated is a block diagram of a particular implementation of a 1 Mb SCRAM in the form of memory 300. The 1 Meg memory array 302 comprises sixteen subarrays 304. Each subarray 304 contains 64 wordlines and 1024 sense amplifiers for a 64 K memory capacity. The DRAM cache 308 also contains 64 wordlines and 1024 sense amplifiers for a 64 K memory capacity. Each subarray 304, therefore, contains 64 K/32 or 2 K 32 bit words of data. The data I/O block 306 can read from, or write to, any of the 16 subarrays 304 or the DRAM cache 308 via the global data read/write bus 310 which is 32 bits wide. Data enters and exits the SCRAM via the data I/O bus 318.

Addresses A<14:0> on address line 316 enter the SCRAM via the address control block 320. Four bits, (e.g. A<14:11>) are used to select one of the 16 subarrays 304, six bits, (e.g. A<10:5>) are used to select one of 64 wordlines within a subarray 304, and five bits, (e.g. A<4:0>) are used to select 32 of 1024 sense amplifiers along a wordline. The address control block 320 provides the ability to latch and/or pre-decode the addresses A<14:0> as needed.

In the particular implementation shown, the tag address bus 326 utilizes only A<10:0> of this address field as the subarray address the cache 308 is mirroring is contained in the mirrored subarray pointer (not shown). The tag address bus 326 also can be multiplexed to accept the write back address from the write-back counter 334. The write-back counter 334 generates an eleven bit write-back address and, therefore, counts from 0 to 2047 recursively. An ability to reset the write-back counter 334 from the control logic block 338 is also provided. The write-back address on bus 336 or the refresh address on bus 330 can be multiplexed onto the cache internal address bus 332. The cache 308 can be accessed using either cache enable, external address or cache enable, cache address signals from the control logic block 338.

A read/write data bus control, not shown, is handled by signals generated in the control logic block 338 and sent to the data I/O block 306, cache 308 and 1 Meg memory array 302. Each of the sixteen subarrays 304 can be enabled by either array enable, external address signal line 340 or array enable, internal address signal line 342. Both these signals are provided to all sixteen subarrays 304 and only the subarray 304 addressed by the enable for that address bus is activated.

In operation, the signal CEB goes “low” to indicate a read or write cycle while the signal WEB goes “low” to indicate a write cycle to the control logic block 338 if the CEB signal is also “low”. The control logic block 338 also contains a timer or counter to provide a REFRESH REQUEST signal.

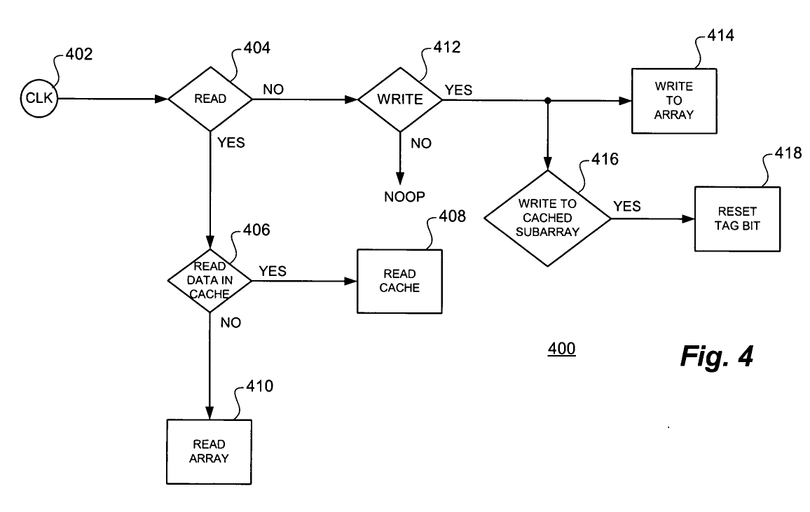

With reference additionally now to FIG. 4, a representative state diagram of a hidden refresh operation 400 of a memory in accordance with the present invention is shown with a REFRESH REQUEST “inactive” (e.g. a logic level “low”). The CLK signal at 402 provides an initiation to a decision 404 as to whether the access to the SCRAM is a read operation or not. If the access is a read, then at decision 406, a determination is made as to whether the data in the cache should be read. If yes, then the cache is read at 408 and, if not, then the array is read at 410.

If the access is determined to not be a read at 404, then a decision is made at 412 as to whether the access is a write or not. If not, then a no operation (NOOP) is indicated. If the access is a write, then the array is written at 414 and a decision is made at 416 if the write is to the cached subarray and, if so, the tab bit is reset at 418.

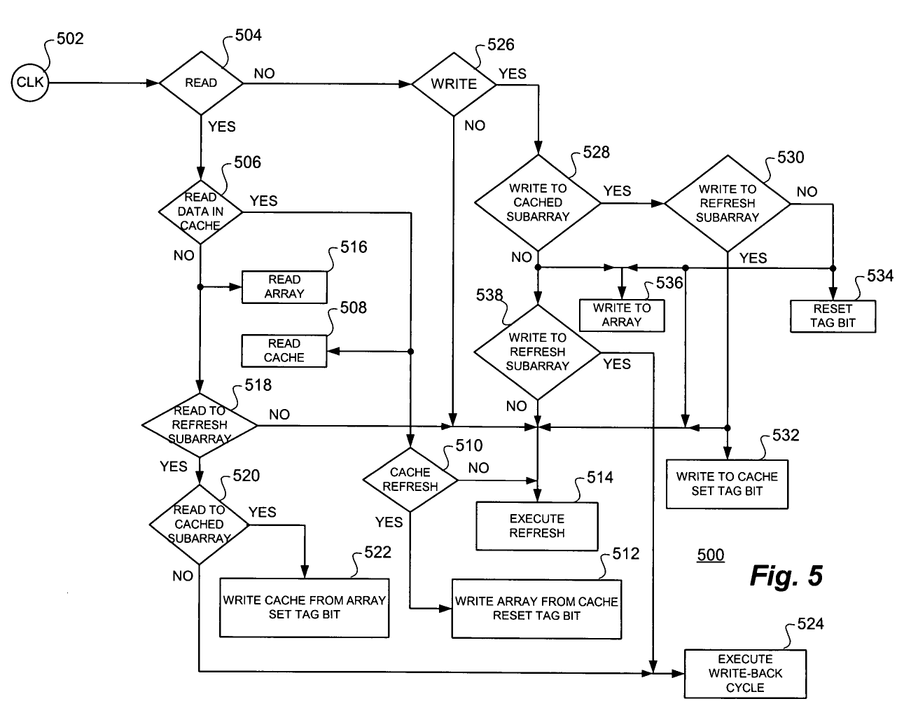

With reference additionally now to FIG. 5, a further representative state diagram of a hidden refresh operation 500 of a memory in accordance with the present invention is shown with a REFRESH REQUEST “active” (e.g. a logic level “high”). The CLK signal at 502 again provides an initiation to a decision 504 as to whether the access to the SCRAM is a read operation or not. If the access is a read, then at decision 506, a determination is made as to whether the data requested by the read is in the cache. If yes, then the cache is read at 508 and a decision as to whether the requested refresh operation is to the cache is made at 510. If yes, then at 512, the array is written from the cache and the tag bit reset. If no, then at 514, the refresh operation is executed.

If at decision 506 a determination is made that the read data is not in the cache, then the array is read at 516 and a decision is made at 518 as to whether the operation is a read and a refresh to the same subarray. If yes, then at decision 520 a further determination is made if the read is to the cached subarray and, if yes, the cache is written from the array and the tag bit set at 522. If not, then a write-back cycle is executed at 524. At decision 518, if the operation is not a read and a refresh to the same subarray, then a refresh is executed at 514.

At decision 504, if the access is not a read access, then at decision 526, a determination is made as to whether the access is a write operation. If yes, then at decision 528, a further determination is made as to whether or not the operation is a write to the cached subarray. If yes, then at decision 530, a determination is made as to whether the operation is a write and refresh to the same subarray. If yes, then at 532, a write is performed to the cache and the tag bit set and a refresh executed at 514. If not, then the tag bit is reset at 534, a write to the array is performed at 536, and a refresh executed at 514. If at decision 528, the write is determined not to be to the cached subarray, decision 538 is also entered as well as a write to the array performed at 536. At decision 538, if the operation is a write and refresh to the same subarray, then a write-back cycle is executed at 524 and, if not, then a refresh is executed at 514 as would be the case at decision 526 if the access were determined to not be a write operation.

With respect to the foregoing two state diagrams, all decisions are initiated by the rising edge of the CLK signal and completed before any actions are allowed to change the state of the SCRAM. All actions reached as a result of the state of the SCRAM at the rising edge of CLK are then completed before any decisions are made for the next clock cycle.

The definitions of the decisions and actions indicate in the preceding figures are described below in more detail as follows:

Decision Steps:

READ—Yes if CEB is “low” and WEB is “high” on the rising edge of CLK.

WRITE—Yes if CEB is “low” and WEB is “low” on the rising edge of CLK.

READ DATA IN CACHE—Yes if the mirrored subarray pointer address is the same as the accessed subarray 304 address and the tag bit corresponding to the accessed word is set.

READ TO REFRESH SUBARRAY—Yes if the refresh pointer address is the same as the accessed subarray 304 address.

READ TO CACHED SUBARRAY—Yes if the mirrored subarray pointer address is the same as the accessed subarray 304 address.

CACHE REFRESH—Yes if the refresh pointer address is the cache address. The cache 308 cannot be addressed externally.

WRITE TO CACHED SUBARRAY—Yes if the mirrored subarray pointer address is the same as the accessed subarray 304 address.

WRITE TO REFRESH SUBARRAY—Yes if the refresh pointer address is the same as the accessed subarray 304 address.

Action Steps:

READ ARRAY—Read data from the 1 Meg memory array 302. The control logic block 338 supplies an array enable, external address signal causing data addressed by the external address bus 322 to be asserted on the global data read/write bus 310. The control logic block 338 also supplies a signal (not shown) to the data I/O block 306 indicating a read cycle causing the data on the global data read/write bus 310 to be transferred to the data I/O bus 318.

READ CACHE—Read data from the cache 308. The control logic block 338 supplies a cache enable, external address signal causing data at locations addressed by the external address bus 322 to be connected to the global data read/write bus 310. The control logic block 338 also supplies a signal (not shown) to the data I/O block 306 indicating a read cycle causing the data on the global data read/write bus 310 to be transferred to the data I/O bus 318. Only external address bits A<10:0> are used when addressing the cache 308 because bits A<14:11> are used for subarray 304 selection.

WRITE CACHE FROM ARRAY—Write data to cache 308 from a subarray 304 being read. The control logic block 338 sends a signal to the data I/O block 306 (signal not shown) indicating that data being read from the global data read/write bus 310 is to be asserted onto the write cache bus 312. The control logic block 338 sends a cache enable, external address signal to the cache 308 as well as a cache load signal (not shown) causing data to be written to the cache 308 at locations addressed by the external address bus 322 via the write cache bus 312. Only external address bits A<10:0> are used when addressing the cache 308 because bits A<14:11> are used for subarray 304 selection.

SET TAG BIT—Write a known state, for example a logic level “high”, into the tag 324 bit location corresponding to the address supplied by the external address bus 322. The control logic block 338 provides a tag write data signal, a tag write signal and a tag enable signal to the tag 324. Only external address bits A<10:0> are used when addressing the tag 324 because bits A<14:11> are used for subarray 304 selection.

EXECUTE REFRESH—Execute a refresh either in one of the subarrays 304 or the cache 308 depending on the refresh pointer. The wordline to be refreshed is specified by the refresh address on bus 330 and the refresh pointer address. The control logic block 338 provides an enable signal, (either array enable, internal address or cache enable, cache address) depending on the refresh pointer address. The control logic block 338 also provides a signal (not shown) to prevent any sense amplifiers (not shown) from being connected to any data bus in the subarray 304 or the cache 308 being refreshed. The refresh counter 328 is also incremented and, if the refresh counter increments to 00000, the refresh pointer is also incremented and the refresh request is reset. If the new refresh pointer address matches the mirrored subarray pointer, the write-back counter is reset.

WRITE ARRAY FROM CACHE—Data being read from cache 308 to the data I/O bus 318 is also written to the 1 Meg memory array 302. A READ CACHE, as described above, is being performed. In addition, the control logic block 338 supplies a signal (not shown) causing the cache 308 sense amplifiers addressed by the external address bus 322 to also be connected to a set of main amplifiers (not shown) that then drive the data onto the read cache, write array bus 344. The control logic block 338 also supplies an array enable, external address signal on line 340 as well as a signal (not shown) causing the sense amplifiers (not shown) addressed by the external address to be connected to the read cache, write array bus 344 and to not be connected to the global data read/write bus 310.

RESET TAG BIT—Write a known state, for example, a logic level “low”, into the tag 324 bit location corresponding to the address supplied by the external address bus 322. The control logic block 338 provides a tag write data signal, a tag write signal and a tag enable signal to the tag 324. Only external address bits A<10:0> are used when addressing the tag 324 because bits A<14:11> are used for subarray 304 selection.

WRITE TO ARRAY—Write data to the 1 Meg memory array 302. The control logic block 338 supplies an array enable, external address signal on line 340 causing sense amplifiers (not shown) addressed by the external address bus 322 to be connected to the global data read/write bus 310. The control logic block 338 also supplies a signal (not shown) to the data I/O block 306 indicating a write cycle causing the data on the data I/O bus 318 to be transferred to the global data read/write bus 310. The data I/O drivers overwrite the data in the sense amplifiers (not shown) connected to the global data read/write bus 310.

WRITE TO CACHE—Write data to the cache 308. The control logic block 338 supplies a cache enable, external address signal causing cache 308 sense amplifiers (not shown) addressed by the external address bus 322 to be connected to the global data read/write bus 310. The control logic block 338 also supplies a signal (not shown) to the data I/O block 306 indicating a write cycle causing the data on the data I/O bus 318 to be transferred to the global data read/write bus 310. The data I/O drivers overwrite the data in the sense amplifiers (not shown) connected to the global data read/write bus 310. Only external address bits A<10:0> are used when addressing the cache 308 because bits A<14:11> are used for subarray 304 selection.

EXECUTE WRITE-BACK CYCLE—Execution of a write-back cycle involves using the write-back address on bus 336. The write-back address is multiplexed onto the tag address bus 326 later in the same cycle that the external address bus 322 address has been used to complete the normal tag 324 read and set/reset. If the bit at the write-back address is set, it is reset and the data in the cache 308 at the write-back address is transferred to the write-back address in the subarray 304 corresponding to the mirrored subarray pointer. It should be noted that the cache 308 access in this case will start later in the clock cycle than in other clock cycles thus imposing a cycle time penalty on EXECUTE WRITE BACK CYCLES. Since all cycles of an SRAM are expected to be the same length, this imposes an access time penalty and may impose a cycle time penalty on the SCRAM.

The state diagrams of FIGS. 4 and 5 assure that the ACTIONS indicated as a result of DECISIONS never conflict. For example, it is not possible to access the cache 308 with both the cache internal address bus 332 and the external address bus 322 in the same cycle. The SCRAM states are designed to assure this type of conflict never occurs. In addition, the states assure that either an EXECUTE REFRESH, WRITE CACHE FROM ARRAY and SET TAG BIT; a WRITE ARRAY FROM CACHE and RESET TAG BIT or an EXECUTE WRITE-BACK CYCLE will occur if a REFRESH REQUEST is “active”. This is important because it assures that either a refresh will occur or progress will be made toward clearing the condition causing the refresh to be delayed.

While there have been described above the principles of the present invention in conjunction with specific implementations of an SCRAM in accordance with the present invention, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. An integrated circuit device comprising:
a dynamic random access memory array comprising a plurality of memory subarrays;
a cache operatively coupled to said plurality of memory subarrays for mirroring any one of said plurality of memory subarrays; and
means for indicating which one of said plurality of memory subarrays is currently being mirrored by said cache.

2. The integrated circuit device of claim 1 wherein said cache comprises dynamic random access memory cells.

3. The integrated circuit device of claim 2 wherein said cache comprises a number of memory cells equal to that of each of said plurality of memory subarrays.

4. The integrated circuit device of claim 2 further comprising:
a refresh counter coupled to said memory array and said cache.

5. The integrated circuit device of claim 4 wherein said refresh counter is coupled to said memory array and said cache through respective internal array and cache address busses.

6. The integrated circuit device of claim 1 further comprising:
an address control block for receiving addresses supplied externally to said integrated circuit device.

7. The integrated circuit device of claim 1 wherein said means for indicating comprises a register.

8. The integrated circuit device of claim 7 further comprising:
an internal array address bus and an internal cache address bus separate from said external address bus.

9. The integrated circuit device of claim 8 further comprising:
a refresh counter coupled to said internal array address bus and said internal cache address bus.

10. The integrated circuit device of claim 8 further comprising:
a write-back counter coupled to said internal array address bus and said internal cache address bus.

11. The integrated circuit device of claim 8 further comprising:
a tag block for tracking valid data in said cache.

12. The integrated circuit device of claim 11 further comprising:
a tag address bus coupled to said tag block and said external address bus.

13. The integrated circuit device of claim 10 further comprising:
a tag block for tracking valid data in said cache coupled to said write-back counter.

14. The integrated circuit device of claim 1 further comprising:
a data input/output block for receiving data to be written to said device and for outputting data to be read from said device.

15. The integrated circuit device of claim 14 further comprising:
a global data read/write bus coupling said data input/output block to each of said plurality of memory subarrays and said cache.

16. The integrated circuit device of claim 14 further comprising:
a write cache bus coupling said data input/output block to said cache.

17. The integrated circuit device of claim 1 wherein each of said memory subarrays comprise a like number of memory cells.

18. The integrated circuit device of claim 8 further comprising:
a control logic block coupled to said external address bus for selectively enabling said plurality of memory subarrays to respond to addresses on either of said internal array address bus or said external address bus.

19. The integrated circuit device of claim 18 wherein said control logic block is further operative for selectively enabling said cache to respond to addresses on either of said internal cache address bus or said external address bus.

20. The integrated circuit device of claim 18 wherein said control logic block is responsive to an externally supplied clock signal.

21. The integrated circuit device of claim 18 wherein said control logic blocks is responsive to an externally supplied write enable.

22. The integrated circuit device of claim 18 wherein said control logic blocks is responsive to an externally supplied chip enable signal.

23. The integrated circuit device of claim 10 further comprising:
a control logic block for supplying an increment signal to said write-back counter.

24. The integrated circuit device of claim 23 wherein said control logic is further operative to supply a reset signal to said write-back counter.

25. The integrated circuit device of claim 23 wherein said control logic block is coupled to receive an output of said write-back counter.

26. The integrated circuit device of claim 4 further comprising:
a control logic block for supplying an increment signal to said refresh counter.

27. The integrated circuit device of claim 26 wherein said control logic is further operative to supply a reset signal to said refresh counter.

28. The integrated circuit device of claim 26 wherein said control logic block is coupled to receive an output of said refresh counter.

29. The integrated circuit device of claim 11 further comprising:
a control logic block for supplying a tag enable signal to said tag block.

30. The integrated circuit device of claim 29 wherein said tag block is operative to supply a tag read data signal to said control block.

31. The integrated circuit device of claim 29 wherein said control logic block is operative to supply a tag write data signal to said tag block.

32. The integrated circuit device of claim 1 wherein refresh operations to said memory array may occur with sufficient frequency to enable device response to a read or write access operation without losing data maintained in said memory array.

33. The integrated circuit device of claim 1 wherein any of said plurality of memory subarrays may be written from said cache or refreshed substantially concurrently with any other of said plurality of memory subarrays being read from or written to.

34. An integrated circuit device comprising:
a dynamic random access memory array comprising a plurality of memory subarrays; and
a cache operatively coupled to said memory array for mirroring only one of said plurality of memory subarrays at a time.

35. The integrated circuit device of claim 34 wherein said cache comprises dynamic random access memory cells.

36. The integrated circuit device of claim 35 wherein said cache comprises a number of memory cells equal to that of each of said plurality of memory subarrays.

37. An integrated circuit device comprising:
a dynamic random access memory array comprising a plurality of memory subarrays; and
a dynamic random access memory cache comprising a number of memory cells equal to that of each of said plurality of memory subarrays.

38. The integrated circuit device of claim 37 wherein said cache is operatively coupled to said memory array for mirroring only one of said plurality of memory subarrays at a time.

39. The integrated circuit device of claim 37 further comprising:
a refresh counter coupled to said memory array and said cache.

40. The integrated circuit device of claim 39 wherein said refresh counter is coupled to said memory array and said cache through respective internal array and cache address busses.

41. An integrated circuit device comprising:
a dynamic random access memory array comprising a plurality of memory subarrays;
a cache operatively coupled to said memory array for mirroring any one of said plurality of memory subarrays;
an array internal address bus coupled to each of said plurality of memory subarrays; and
a cache internal address bus coupled to said cache.

42. The integrated circuit device of claim 41 further comprising:
a refresh counter coupled to said memory array and said cache.

43. The integrated circuit device of claim 42 wherein said refresh counter is coupled to said memory array and said cache through said array internal and cache internal address busses respectively.

44. The integrated circuit device of claim 41 further comprising:
a write-back counter coupled to said array internal address bus and said cache internal address bus.

45. The integrated circuit device of claim 41 further comprising:
an address control block for receiving addresses supplied externally to said integrated circuit device; and
an external address bus coupled to said address control block and to said cache and plurality of memory subarrays.

46. The integrated circuit device of claim 45 further comprising:
a tag block for tracking valid data in said cache.

47. The integrated circuit device of claim 46 further comprising:
a tag address bus coupled to said tag block and said external address bus.

48. An integrated circuit device comprising:
a dynamic random access memory array comprising a plurality of memory subarrays;
a cache operatively coupled to said memory array for mirroring one of said plurality of memory subarrays; and
an address control block for receiving addresses supplied externally to said integrated circuit device and coupled to said cache and said plurality of memory subarrays by an external address bus.

49. The integrated circuit device of claim 48 wherein said cache mirrors only one of said plurality of memory subarrays at any one time.

50. The integrated circuit device of claim 48 further comprising:
an array internal address bus coupled to each of said plurality of memory subarrays; and
a cache internal address bus coupled to said cache.

51. The integrated circuit device of claim 50 further comprising:
a refresh counter coupled to said memory array and said cache.

52. The integrated circuit device of claim 51 wherein said refresh counter is coupled to said memory array and said cache through said array internal and cache internal address busses respectively.

53. The integrated circuit device of claim 50 further comprising:
a write-back counter coupled to said array internal address bus and said cache internal address bus.

54. An integrated circuit device comprising:
a dynamic random access memory array comprising a plurality of memory subarrays; and
means for substantially concurrently accessing more than one of said memory subarrays.

55. The integrated circuit device of claim 54 wherein said means for substantially concurrently accessing comprises an array internal address bus and a separate external address bus coupled to said plurality of memory subarrays.

56. The integrated circuit device of claim 55 further comprising:
an array external address signal for indicating an address is to be accessed based on said external address bus; and
an array internal address signal for indicating an address is to be accessed based on said array internal address bus.

57. The integrated circuit device of claim 54 further comprising:
a cache operatively coupled to said plurality of memory subarrays for mirroring any one of said plurality of memory subarrays.

58. An integrated circuit device comprising:
a DRAM array comprising a plurality of subarrays;
a cache having at least as many memory cells as that of each of said subarrays;
means for refreshing any one of said subarrays substantially concurrently with an access to another one of said subarrays;
means for writing data to said cache being read from said DRAM array;
means for writing data to said cache instead of writing to said DRAM array;
means for reading data from said cache instead of reading from said DRAM array;
means for transferring data from said cache to any one of said subarrays substantially concurrently with an access to another one of said subarrays;
means for indicating locations within said cache which contain valid data;
means for indicating from which one of said plurality of subarrays said cache may be mirroring valid data; and
control circuitry enabling the hiding of refresh operations to said DRAM array.

59. The integrated circuit device of claim 58 wherein said cache is equal in size to each of said plurality of subarrays.

60. The integrated circuit device of claim 58 wherein said cache comprises a DRAM cache.

61. The integrated circuit device of claim 60 wherein said control circuitry is further operative to enable hiding of refresh operations to said DRAM cache.
